(19) United States
(12) Patent Application Publication
(10) Pub. No.: US 2012/0034358 A1
(43) Pub. Date: Feb. 9, 2012

(54) Lobster Processor

(76) Inventors: James Almeida, Norcross, GA (US); David Almeida, Middleboro, MA (US)

(21) Appl. No.: 13/021,522

(22) Filed: Feb. 4, 2011

Related U.S. Application Data
(60) Provisional application No. 61/370,874, filed on Aug. 5, 2010.

(51) Int. Cl. A23L 1/325; A22C 29/02

(52) U.S. Cl. 426/480; 452/1; 452/9

(57) ABSTRACT

A lobster processing apparatus and method that includes a rotatable housing and several stations for extracting meat from a lobster. The housing is a cubic structure, which on each side comprises a different means for cleaning and disassembling a lobster for consumption. These include a vertical cutter device with a retracting blade, a pressure crunching vice for cracking lobster claws, a dual roller system for extruding meat from lobster appendages, and finally a mincing device for processing extracted lobster meat. Below the rotatable housing is an extendable drip pan with pull-out trays and a removable drip collector for spilled liquid. The housing is rotated to align each station above the drip tray during use, thereby allowing each processing station to rotate towards a seated or stationary user. Inside the housing is a means for supplying electric power to each processing device, supplied via batteries or an external A/C power source.

### CROSS REFERENCE TO RELATED APPLICATION

This application claims the benefit of U.S. Provisional Application No. 61/370,874 filed on Aug. 5, 2010 entitled “Lobster Processor”

### BACKGROUND OF THE INVENTION

1. Field of the Invention

The present invention relates to lobster processing devices and methods for preparing and extracting meat from cooked lobsters and similar crustaceans prior to consumption.

2. Description of the Prior Art

Various devices have been described in the art for removing meat from crustacean bodies and appendages, however all share several common disadvantages. Most devices are intended for industrial applications or for use in a commercial kitchen. In this environment, devices can be quite large and involve several complex mechanical parts such as conveyor belts and gearing mechanisms. At the dinner table or at a serving table, lobster claw crackers, mallets and sharp knives are required to separate lobster meat from their hard exoskeleton. A solution is required that removes the dangers and hassle of preparing a lobster for consumption without requiring a large apparatus that does not operate well in a domestic environment.

Another common drawback to existing lobster processing devices is that most incorporate only a singular mode of shelling a lobster. This mode may include a cutting blade, a roller mechanism, a mincer, or other shelling technique for separating the parts of a lobster's segmented body. None incorporate a plurality of functions that allow the user to extract and prepare meat from the body, legs and claws using one device.

### SUMMARY OF THE INVENTION

In view of the foregoing disadvantages inherent in the known types of lobster processors now present in the prior art, the present invention provides a new lobster processing apparatus and method wherein the same can be utilized for providing convenience for the user when preparing and extracting meat from a lobster or similar crustacean.

It is therefore an object of the present invention to provide a rotatable, multi-station device that incorporates several processing functions, including a cutting tool, a mincing device, a crusher and extruding roller for extracting meat from lobster appendages and exoskeleton shells.

Another object of the present invention is to provide a device suitable for commercial and non-commercial kitchens, as well as for use on a dining or serving table for extracting meat from a lobster or similar crustacean.

Another object of the present invention is to provide a multi-station tool that reduces time and user effort required to extract meat from a lobster.

Yet another object of the present invention is to provide a method of processing a lobster using a single device, in which multiple stations are utilized to extract meat from several sources in the lobster's body and limbs.

Other objects, features and advantages of the present invention will become apparent from the following detailed description taken in conjunction with the accompanying drawings.

### BRIEF DESCRIPTIONS OF THE DRAWINGS

FIG. 1 shows a view of the lobster processor cutting station ready for use over the extendable drip pan and fold-out trays.

FIG. 2 shows a view of the lobster processor pressure crushing station ready for use over the extendable drip pan and fold-out trays.

FIG. 3 shows a view of the lobster processor meat mincer station ready for use over the extendable drip pan and fold-out trays.

FIG. 4 shows a view of the lobster processor dual roller extruding station ready for use over the extendable drip pan and fold-out trays.

FIG. 5 shows a view of the lobster processor rotating motion above the base structure.

FIG. 6 shows a cut-out view of the stabilizing support structure mounted beneath the lobster processor base structure.

FIG. 7 shows a view of the lobster processor drip pan and fold-out trays and their extending motion from the processor base structure.

### DETAILED DESCRIPTION OF THE INVENTION

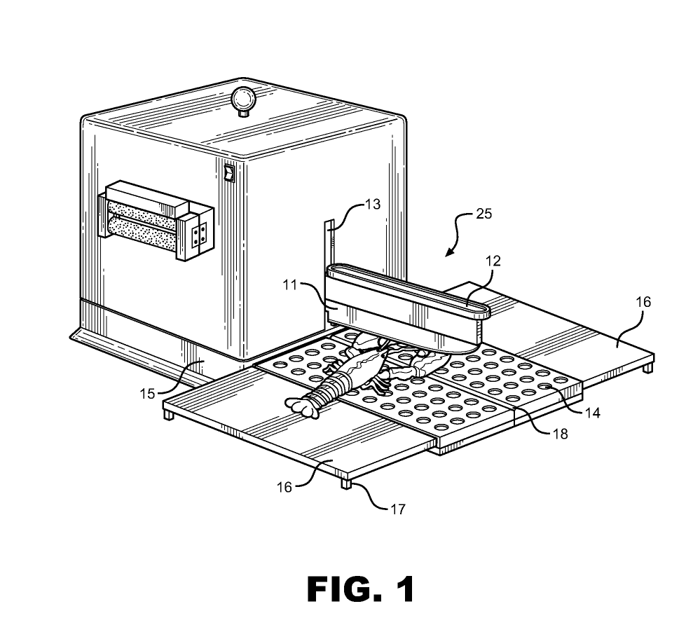

Referring now to FIG. 1, there is shown a view of the lobster processor vertical cutting station 25 in use. An elongated cutting blade 11 is positioned beneath a push-down handle 12. The handle 12 includes a cavity in which the blade 11 retracts into when the handle 12 is not depressed and is at the top of the guide rail 13. As the handle 12 is depressed downwards towards the drip pan 14, the blade 11 extends from inside the handle 12 cavity. This allows the blade to be sheathed when not in used, a safety device which prevent inadvertent injury from an exposed blade. The drip pan 14 extends outward from the base structure 15 of the processor. When not in use, the drip pan 14 can be slide beneath the processor into the base structure 15. While extended, two fold-out trays 16 are slideable from beneath the grating of the drip pan 14. Two foldable legs 17 extend down from the ends of each tray 16 for support.

The cutting station 25 is used to remove the claws and legs of the lobster, as well as separate its midsection for extraction of meat. The cutting blade 11 and handle 12 are spring-mounted to provide resistance to vertical loads and allow the blade to be sheathed at the top of the guide rail 13 when not in use. A notch 18 in the drip pan 14 allows the blade to extend below the plane of the drip pan upper plate and the fold-out trays 16, ensuring a complete through-cut of material placed below the cutting blade 11. Fluids and the other byproducts of each process collect in the drip pan 14 for easy containment and later clean-up. In use, the user grips the support knob above the processor with one hand, and places his or her other hand above the handle 12 of the cutting blade 11 to apply the required downward force to lower the blade from its sheathed position and cut through material placed below the blade 11. The blade then returns to the top of the guide rail 13 and resheath itself inside the handle 12.

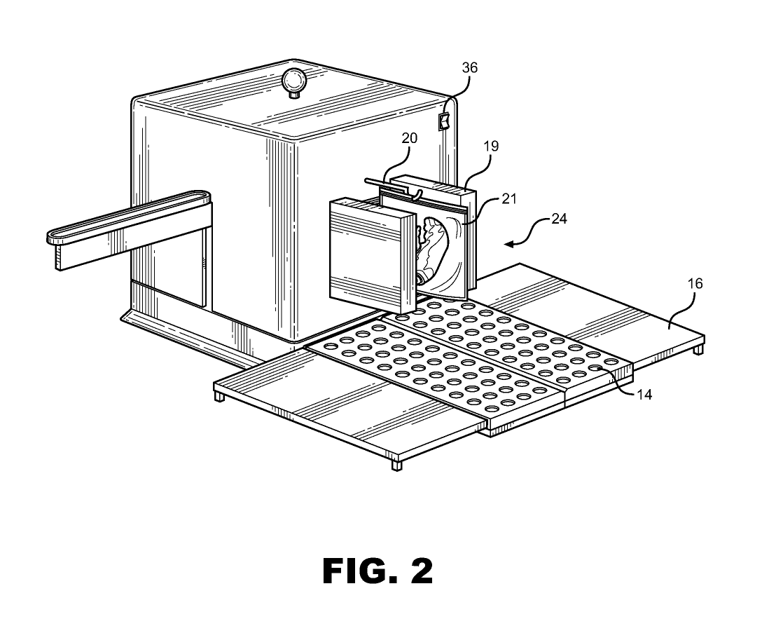

Referring now to FIG. 2, there is shown a view of the lobster processor pressure crushing station 24 ready for use over the extendable drip pan 14 and fold-out trays 16. Two horizontally opposed vice blocks 19 move along a track that allows the gap between the blocks to widen and close using either a manually operated crank means or an electric actuation means. The blocks 19 provide a crushing vice to crack a lobster claw prior to meat extraction. The tracks do not allow the blocks to completely mate against one another, preventing inadvertent injury resulting from pinched fingers. A hook 20 is provided above the blocks 19 to attach lobster claw inside of a fluid containment bag 21. The containment bag 21 prevents the fluids and meat of the claw from spilling out while the hook allows the user to keep his or her hands away from the vice while in use. An internal electric motor powers the crushing vice and allows the blocks to move along the tracks. The direction and control of the electric motor is provided via a raised, two-way switch 36. The user depresses the upper portion or the lower portion to contract or expand the gap between the vice blocks 19. In an alternative embodiment, a manual hand crank is supplied to eliminate the electric motor and allow operation of the crushing vice 24 via manual power.

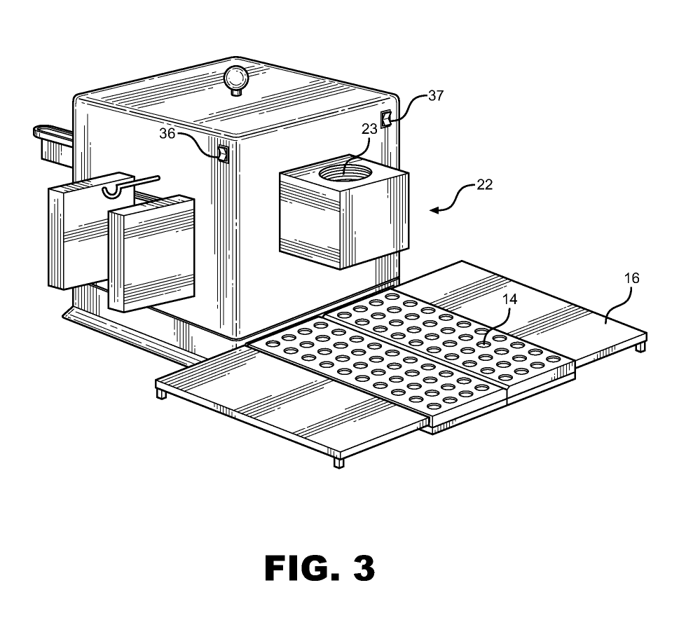

Referring now to FIG. 3, there is shown a view of the lobster processor meat mincer station 22 ready for use over the extendable drip pan 14 and fold-out trays 16. The mincer is a device that contains blades for chopping and mincing extracted meat. The meat is placed in the top inlet 23 of the mincer and a prop screw mincer blade internal to the mincer device chops the meat into fine segments. The mincer device 22 is powered by electric power or via hand crank means, similar to the vice block station. An electric motor spins the internal mincer blade as meat passes through the device, and is controlled via an electric switch 37. A cap or closure means for the mincer inlet 23 prevents debris from exiting the inlet and can be used to force meat into the mincer towards the spinning blades. Below the mincer 22, a bowl or other collection means may be placed to collect the minced meat after passing through the mincer.

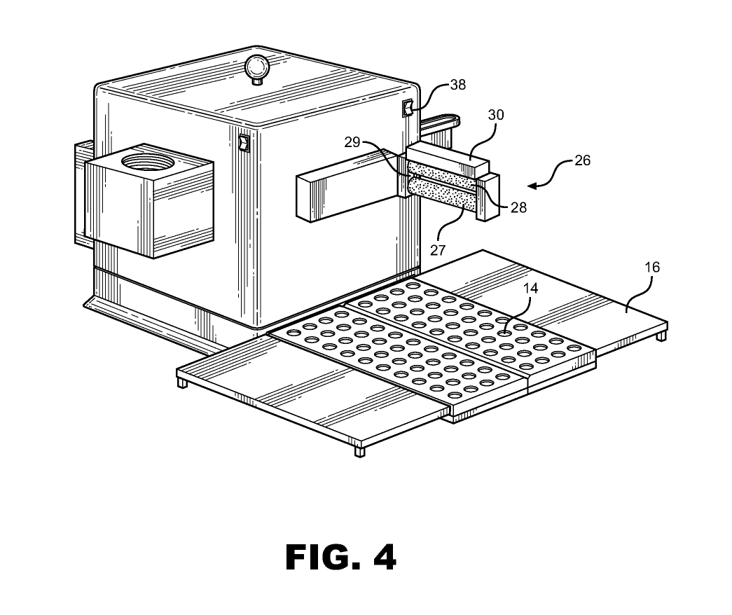

Referring now to FIG. 4, there is shown a view of the lobster processor dual roller extruding station 26 ready for use over the extendable drip pan 14 and fold-out trays 16. Two vertically-stacked rollers 27, 28 are separated by a gap and a vertical roller track 29. Above the upper roller 28 is a push-down handle 30 for the user to reduce the gap between the upper and lower rollers 27, 28. The reduced gap between the rollers 27, 28 places compression loads between the rollers and works to extrude meat from a lobster leg work piece that passes between the rollers. The rollers are turned in opposite directions relative to each other in order to accept a lobster leg and pass it through the rollers. The turning operation is achieved via electric motors and controlled by an electric switch 38. An alternative embodiment to this station includes a manual hand crank for turning the rollers. The surface of each roller is covered with a high-friction compound to increase the friction coefficient of the surface of the rollers 27, 28. In use the user places force on the push-down handle 30 as the rollers 27, 28 are turned. A lobster leg is fed between the rollers and meat is extruded from the leg exoskeleton for collection and consumption. An optional tray or bowl may be placed below the rollers 27, 28 and on the drip pan 14 to collect the extruded meat. When not in use, the rollers are pivoted against the housing of the processor.

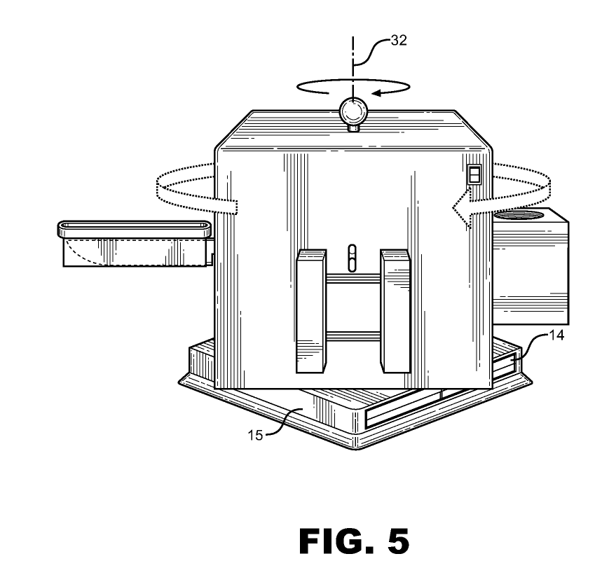

Referring now to FIG. 5, there is shown a view of the processor housing rotating 31 above the base structure 15. To operate a particular station, the processor housing is rotated about its center 32 to place that station above the drip tray 14, which is extendable from the base structure 15. This allows each station to face the user, rather than the user having to lift and rotate the entire device or walk around the device to use a particular station.

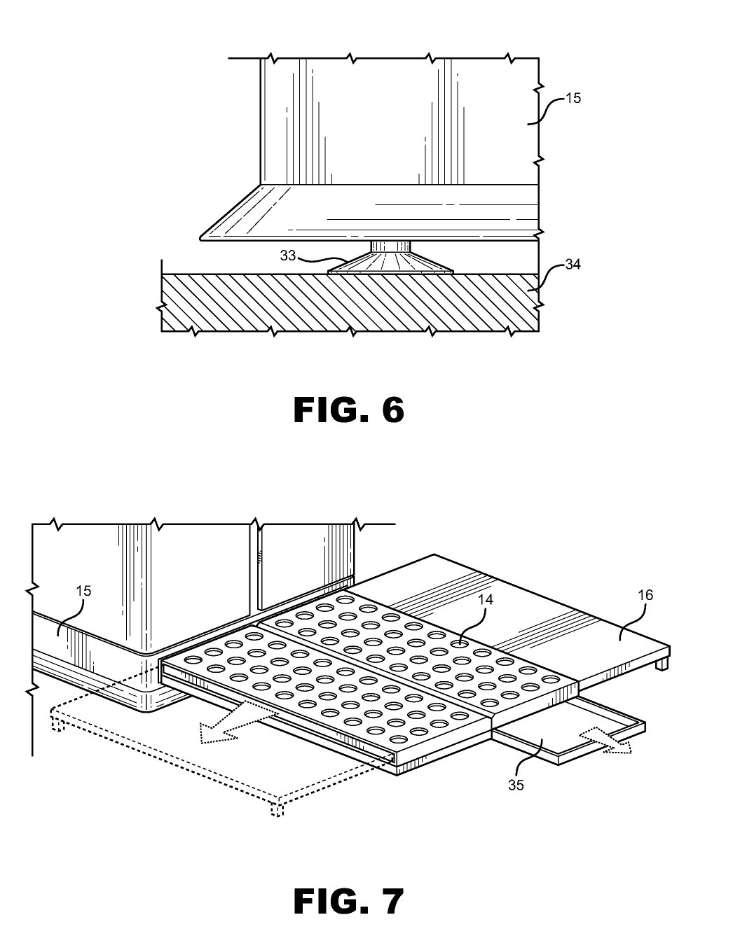

Referring now to FIG. 6, there is shown the support stands 33 placed below all four corners of the base structure 15. The support stands are rigid supports with a high friction lower surface, eliminating slip between the stands 33 and the ground support 34. Alternatively, the support stands 33 may comprise suction cup devices that create a vacuum between the stands 33 and the ground support 34, keeping the processor in place while in use. The suction cups may also alternatively incorporate a lever which draws a vacuum seal between the stands 33 and the ground 34.

Referring now to FIG. 7, there is shown a view of the lobster processor drip pan 14 and fold-out trays 16 and their extendable motion from the processor base structure. While one of the processing functions is in use, the drip pan 14 is pulled from a cavity within the base structure 15 of the processor to an extended position. The drip pan 14 top surface is a perforated metal sheet that allows fluid to pass into two removable drip containers 35. These containers can be removed to empty spilled fluid, washed and then replaced beneath the drip pan assembly 14. Two fold-out trays 16 extended laterally from the drip pan expand the workspace for processing a lobster for a given station. The trays 16 each have two fold-down legs 17 which provide structural support. When the processor is not in use, the drip pan 14 and fold-out legs 16 are condensed and slid back into the cavity of the base structure 15, saving space. In an alternative embodiment to the drip pan, securing blocks are provided to position the lobster and hold it firmly in place when operating the different stations. The securing means may include two lateral blocks that are placed on the drip pan to physically confine the lobster, or it may include a series of securing arms that grip the lobster.

In use an individual is able to prepare a cooked lobster for consumption by utilizing any and all of the four processing stations. The cutting station 25 is used to remove the limbs of the lobster, cut the exoskeleton for extraction of meat, and separate the head from the segmented body of the lobster. The claw crushing station 24 is useful for cracking the hard outer shell of a lobster claw without risking injury from a cutting tool or pinching one's finger inside a vice grip. The meat mincer station 22 is used to mince extracted meat using a prop screw cutting device. Finally the dual roller extruding station 26 is used for extruding meat from a lobster leg or other appendage by compressing the leg between two opposed, rotating rollers.

The housing of the processor is rotatable about the base structure to improve ergonomics and ease of use. Each station operates using supplied electric power, which operates electric motors for each station. Alternatively, manual hand cranks and gearing mechanisms may be supplied for each station to eliminate any requirement for electric power. Input power via electric power or manual input are two embodiments of the processor. Utilization of either mode depends on the application and user preference. Electric power may be supplied by battery power or an attached A/C power source that feeds internal electric motors. For safety reasons, electric power is only supplied to a particular station when it is rotated above the drip pan 14. Connection to the power source is made as the station is aligned over the drip pan and is locked in place. Those stations not being utilized, and while placed away from the drip pan 14, are collapsed against the housing of the processor and are not provided any power to function. This improves safety and the compaction of the device. An internal slip ring device is used to transfer electric power from the power source to the electric motors of each station. The slip ring allows the processor to be freely rotated in either direction while maintaining electrical connectivity.

Each station requiring electric power is supplied an electric switch to apply power and control over the station above the drip tray. The switch defaults to an ‘off’ selection, with two additional positions that supply positive or negative movements for each station. Specifically, for the dual roller extruding station, the switch controls the direction of the rollers' rotation, allows the lobster legs to be fed from either direction or the leg to be fed and reversed if necessary. For the mincer station, the switch controls the direction of rotation for the mincer prop screw blade, clockwise or counter clockwise. For the pressure crushing station, the switch controls the direction of translation for both vice blocks, allowing the gap to close or widen between the two blocks.

Associated with the lobster processing device is a method of use that includes extracting meat from a lobster using any or all of processing stations. A whole lobster may be shelled and processed using a combination of all four stations. First, the drip pan is accessed from the base structure of the processor and extended outward toward the user. The folding trays are extended from the sides of the drip tray and their support legs are extended. Once expanded, a lobster is placed on the drip pan beneath the vertical cutting station. The lobster body may be oriented either parallel or perpendicular to the length of the cutting blade depending on the cutting operation of choice. Once positioned, the cutting blade is used to separate the limbs from the lobster as well as cut the body of the lobster from the head. The body of the lobster can also be cut down the centerline of the main body to create two halves for meat extraction.

Once the limbs and claws have been separated, and the meat from the main body is accessible, the processor housing is rotated to align another station in front of the drip pan. Lobster claws can be very difficult to access meat from because of their extremely tough outer shell. Before meat can be removed from the claws, they must be cracked using the pressure crunching station. A claw or claws are placed inside of a fluid containment bag, comprising a clear plastic or similar type bag. The bag is hung from a hook between the two vice blocks, and the user translates the blocks together until enough compressive load is imparted on the claws to cause rupture. Once rupturing has occurred, the claw shell can be broken and the meat is extracted.

After this process, the processor housing is again rotated to place a third processing station in alignment with the drip pan. For extracting meat from a lobster's legs, the dual roller extruding station is utilized. The user expands the rollers to a position their cylindrical centerlines perpendicular to the housing, and powers the rotation of the rollers. A lobster leg is placed between the rotating rollers while vertical load is applied to the push-down handle. The rollers are covered with a gritty, frictional compound that prevents the lobster legs from slipping against the rollers' surfaces. As the leg is fed through, a rolling pressure is applied that extrudes the meat from the legs. A containment bowl is placed on the drip pan to collect the extruded leg meat.

Once this process is completed, meat from the legs, claws and main body of the lobster is accessible. Further processing of the meat is possible by rotating the processor housing to align the meat mincer station with the drip pan. Meat is fed into the mincer inlet as the mincer internal prop screw blade is rotating. A protective cap is placed above the inlet to force the meat into the inlet and prevent meat from exiting during use. The meat is chopped into finer segments and travels through the mincer towards the outlet. A collection bowl beneath the mincer is used to recover the minced lobster meat as it exits. After this station is utilized, the meat has been completely removed from the lobster shell and is prepared for consumption.

Each station may be stowed appropriately against the processor housing when not in use above the drip pan, including the cutting blade and the extended roller. Corresponding electrical power is withheld from stations when positioned away from the drip pan. After all lobster processing stations have been utilized, the drip containers are removed from the drip pan, emptied of fluid and cleaned. The fold-out trays are collapsed inside the drip pan and the assembly is stored inside the base structure for compact storage.

The method of processing a lobster is not dependent on the exact design of the stations, but rather the steps of utilizing a single device that comprises several processing functions. The device includes a rotatable processor housing and four stations, including a cutting station, a claw cracking station, a leg meat extruding station and a mincing station. The cutting station includes a means for separating a lobster into segments using a cutting blade. The claw cracking station includes means for applying external pressure to a lobster claw to cause rupture of the outer shell. The leg meat extruding station includes a means for compressing and extruding meat from a lobster leg. Finally, the mincing station provides a means for dicing and micing extracted meat prior to consumption, using a blade or cutting tool.

Any combination or permutation of this method, including the order of these devices can be utilized to processor a lobster. This includes subcombinations that utilize only certain stations. A single station may also be used repetitively to process multiple lobsters, one after another using a single mode of meat extraction or shelling. Full or partial lobster can be processed as well, depending on user preferences and occasion.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A lobster processing device for preparing and extracting meat from a lobster or similar crustacean, comprising:
A housing that includes four processing stations, including a vertical cutting station, a pressure crushing station, a dual roller extruding station, and a meat mincing station.

2) The apparatus of claim 1, wherein said vertical cutting station comprises an elongated cutting blade interiorly mounted inside a push-down handle, said push-down handle is slideably attached along a vertical guide rail of said lobster processor; said guide rail has an upper and lower stop and a vertical track; said handle and cutting blade are spring-mounted along said vertical track to allow said handle and cutting blade to return to said upper stop when not in use; said cutting blade extends from an interior position inside said push-down handle to an unsheathed position as said push-down handle is moved from said upper to said lower stop.

3) The apparatus of claim 1, wherein said pressure crushing station comprises two horizontally opposing vice blocks, a horizontal track, and a work piece hook above and between said vice blocks; said vice blocks translate towards one another along said horizontal track, compressing a lobster appendage held by said work piece hook.

4) The apparatus of claim 3, wherein said translation along said track is powered via an electric motor internal to said processor housing; an electrical switch with a first, second and third position controls said motor; said first position provides no translation to said blocks, said second position translates said blocks towards one another along said track, and said third position translates said blocks away from one another along said track.

5) The apparatus of claim 3, wherein said translation along said track is powered via a mechanical crank and a gearing mechanism internal to said processor housing;
said mechanical crank is rotated clockwise to translate said blocks towards one another along said track; said mechanical crank is rotated counterclockwise to translate said blocks away from one another along said track.

6) The apparatus of claim 1, wherein said meat mincing station comprises an inlet, and interior rotating prop screw mincer blade, and an outlet; said prop screw mincer blade rotates as meat is place through said inlet, and meat exits said mincing device outlet.

7) The apparatus of claim 6, wherein said rotation of said prop screw mincer blade is provided via electric power and an electric motor; an electrical switch with a first, second and third position controls said motor; said first position provides no rotation to said prop screw mincer blade; said second position provides clockwise rotation of said prop screw mincer blade, and said third position provide a counter clockwise rotation of said prop screw mincer blade.

8) The apparatus of claim 6, wherein said rotation of said prop screw mincer blade is provided via a mechanical hand crank and gearing mechanism; clockwise rotation of said hand crank provides a clockwise rotation of said prop screw mincer blade, and counter clockwise rotation of said hand crank provides a counter clockwise rotation of said prop screw mincer blade.

9) The apparatus of claim 1, wherein said dual roller extruding station comprises an upper cylindrical roller, a lower cylindrical roller, a compression handle, and a vertical roller track; said upper roller is slideably spring-mounted along said vertical roller track, and said compression handle is mounted above said upper roller along said track; said upper roller and lower roller are rotatably mounted along said vertical roller track; said upper and lower rollers rotate along each roller's longitudinal axis, in opposite directions; said compression handle translates said upper rail along said roller track, reducing a gap between said upper and lower rollers, creating an extruding process for lobster appendages; said upper roller returns to an upper stop along said vertical roller track when said compression handle is not translating said upper roller.

10) The apparatus of claim 9, wherein said dual roller extruding station is collapsibly mounted to said processor housing to allow said cylindrical rollers to extend from an initial position where said roller's longitudinal axis is parallel to said housing, to a working position where said roller's longitudinal axis is perpendicular to said housing.

11) The apparatus of claim 9, wherein said rotation of said upper and lower rollers is provided via electric power and electric motors; an electrical switch with a first, second and third position controls said motor; said first position provides no rotation of either said rollers, said second position rotates said rollers in opposite rotational direction, and said third position rotates said rollers in opposite rotational directions than said second switch position.

12) The apparatus of claim 9, wherein said rotation of said upper and lower rollers is provided via a manual hand crank and a gearing mechanism; clockwise rotation of said hand crank rotates said rollers in opposite rotational directions from one another, counter clockwise rotation of said hand crank rotates said rollers in opposite rotational directions than provided by said clockwise rotation of said hand crank.

13) The apparatus of claim 1, wherein said housing is rotatably mounted to a base structure.

14) The apparatus of claim 13, wherein said base structure supports said housing four high-friction support stands, and said base structure provides an enclosure for an extendable drip pan and fold-out trays.

15) The apparatus of claim 13, wherein said processor stations are rotated to a working position above said drip pan, and said station in its working position is supplied electrical power via a slip ring device; said electrical power is supplied only to said station in its working position, and unpowered when rotated to a position away from said drip pan.

16) A method of preparing and extracting meat from a lobster or similar crustacean, comprising the steps of:
utilizing a single device to separate and extract meat from a lobster, including rotating a four-station housing composed of a cutting station, a claw cracking station, a leg meat extruding station and a mincing station; said housing is rotated to access any or all of said stations; said cutting station is used to separate a lobster into several pieces, including legs, claws, and midsection; said claw cracking station is used to compress and rupture said lobster claws; said leg meat extruding station is used to extract meat from said lobster legs, and said lobster meat mincing station is used to mince said lobster meat.
